(19) United States
(12) Patent Application Publication
(10) Pub. No.: US 2023/0408015 A1
(43) Pub. Date: Dec. 21, 2023

(54) PROPANE DISTRIBUTION SYSTEM FOR A RECREATIONAL VEHICLE

(71) Applicant: SBC Holdings LLC, South Bend, IN (US)

(72) Inventors: Christopher KAPSASKIS, Colts Neck, NJ (US); Zachary GRASSI, South Bend, IN (US); John KOSOWSKI, South Bend, IN (US); Joseph CIRILLO, Freehold, NJ (US)

(21) Appl. No.: 18/331,406

(22) Filed: Jun. 8, 2023

Related U.S. Application Data
(60) Provisional application No. 63/350,613, filed on Jun. 9, 2022.

(51) Int. Cl. F16L 41/03

(52) U.S. Cl. CPC F16L 41/03; B60R 16/08

(57) ABSTRACT

A propane supply system comprising a distribution manifold block having barbed fittings, a propane supply tank, an appliance or system for using propane, a propane supply hose connecting the propane supply tank to the distribution manifold block, a distribution hose connecting the distribution manifold block to the appliance or system for using propane, and a plurality of crimped tubes. The crimped tubes are positioned over each of the propane supply hose and the at least one propane distribution hose and the associated barbed fittings. The propane supply hose and the propane distribution hose are fixed to the distribution manifold block using connectors without helical threads.

### CROSS-REFERENCE TO RELATED APPLICATION

This claims the benefit of U.S. Provisional Application No. 63/350,613, filed Jun. 9, 2022, the disclosure of which is hereby incorporated by reference in its entirety.

### FIELD OF THE INVENTION

The present invention relates to recreational vehicle, and in particular to a propane distribution system for a recreational vehicle.

### BACKGROUND OF THE INVENTION

Recreational vehicles can have several appliances or systems that receive propane. The propane can provide gas to a furnace to heat the recreational vehicle, to a water heater to heat water, power a stove and a refrigerator, and fuel barbecue grills, griddles or other small appliances. The propane is provided by a refillable propane tank located on or within the recreational vehicle.

Prior art recreational vehicles have included several systems for supplying the propane from the propane tank to the several appliances or systems using the propane. Every model of recreational vehicle has a different floorplan, lengths, layout and locations of varying appliances. Therefore, every model of recreational vehicle has a unique distribution layout.

A first prior art system for supplying the propane from the propane tank to the several appliances or systems using the propane comprises a system of black iron pipes, the black iron pipes being connected to each other with accompanying black iron pipe helically threaded fittings. The pipes are typically straight and the fittings include inline joints, angled joints, T-joints that split gas from the source into two black iron pipes leading to different appliances or systems, or similar joints. The black iron pipes are helically threaded into the fittings.

The propane supply system of black iron pipes connected to each other with accompanying black iron pipe helically threaded fittings are prone to several undesirable issues. First, the helically threaded connections between the black iron pipes and the black iron pipe helically threaded fittings can sometimes be prone to leaks. The weakest link in the black iron pipe supply system is at helically threaded connection points between the black iron pipes and the black iron fittings. Almost all leaks in this system occur at the helically threaded connection points. In addition, the helically threaded connection points are typically located under the vehicle such that the helically threaded connection points are exposed to the elements which can cause sealant used in the helical threads to deteriorate over time. Moreover, the supply system comprising the black iron pipes and the black iron pipe helically threaded fittings is very rigid. Since the frame of the recreational vehicle is constantly flexing during movement, the rigidity of the black iron supply system puts unnecessary stress on the helically threaded connection points, which may lead to leakage or failure.

Second, the black iron supply system is difficult and time consuming to assemble. Likewise, performing maintenance on the black iron supply system can be difficult and time consuming. Black iron pipes are very rigid such that the black iron pipes can be difficult to maneuver into place. In addition, the black iron pipes often must be custom cut and helically threaded. Furthermore, once the black iron supply system is fully assembled on the recreational vehicle, replacing a faulty section can be very difficult because the rest of the black iron system is helically threaded onto the faulty section that needs to be cut or fully disassembled to replace the faulty section. Moreover, preparing the black iron pipes and the black iron pipe helically threaded fittings to exactly replace the faulty section can be difficult and often must be performed by the manufacturer of the recreational vehicle.

Third, the black iron of the black iron supply system is susceptible to rust and rot. Since the black iron supply system is mounted under the chassis of the recreational vehicle, the black iron supply system is exposed to the elements. Water, rain, snow, salt and other elements can cause deterioration of the black iron over time and can thereby cause undesirable rusting and/or failure of the black iron supply system.

A second prior art system for supplying the propane from the propane tank 18 to the several appliances or systems 20 using the propane comprises a prior art propane supply system 10 as illustrated in FIG. 1 of flexible PVC hoses 12 with helically threaded ends 14 that helically thread into a distribution manifold block 16. The prior art propane supply system 10 is also prone to several undesirable issues. First, the helically threaded connections at the helically threaded ends 14 are prone to leaks. The weakest link in the prior art propane supply system 10 is the helically threaded connection points between the helically threaded ends 14 typically comprising male brass helically threads located on the PVC hoses 12 and female helically threaded areas of the distribution manifold block 16 typically made of aluminum that receive the helically threaded ends 14. Almost all leaks in the prior art propane supply system 10 occur at the helically threaded connections. Moreover, the helically threaded connections are located under the recreational vehicle, thereby exposing the helically threaded connections to the elements which can cause sealant used in the helically threaded connections to deteriorate over time.

Second, manufacturing the prior art propane supply system 10 is very difficult and time consuming. As outlined above, the helically threaded ends 14 comprising male brass threads are helically threaded into the distribution manifold block 16 of aluminum. The difference in aluminum and brass material hardness can lead to complications including breaking, splitting, cross-threading and other failure at the connection points.

Third, the prior art propane supply system 10 is susceptible to galvanic corrosion. All dissimilar materials have the potential to react with each other when brought together in the presence of a catalyst. When some materials are used in combination and then exposed to an electrolyte, such as water, the effects can become problematic. In the damp conditions under the recreational vehicle, the use of the distribution manifold block 16 of aluminum connected to helically threaded ends 14 comprising male brass helically threads can be problematic, and lead to galvanic corrosion, which means potential failure/leaks in the prior art propane supply system 10 at the helically threaded connections.

It is desirable to devise a propane distribution system for a recreational vehicle that avoids the issues of the prior art propane distribution systems for a recreational vehicle.

### SUMMARY OF THE INVENTION

The present invention, according to one aspect, is directed to a propane supply system comprising a distribution manifold block, a propane supply tank, at least one appliance or system for using propane supplied from the propane supply tank, a propane supply hose connecting the propane supply tank to the distribution manifold block, and at least one propane distribution hose. Each at least one propane distribution hose connects the distribution manifold block to one of the at least one appliance or system for using propane. The propane supply hose and the at least one propane distribution hose are fixed to the distribution manifold block using connectors without helical threads.

Another aspect of the present invention is to provide a propane supply system comprising a distribution manifold block having a plurality of barbed fittings, a propane supply tank, at least one appliance or system for using propane supplied from the propane supply tank, a propane supply hose connecting the propane supply tank to the distribution manifold block, at least one propane distribution hose, with each at least one propane distribution hose connecting the distribution manifold block to one of the at least one appliance or system for using propane, and a plurality of crimped tubes. The crimped tubes are positioned over each of the propane supply hose and the at least one propane distribution hose and the associated barbed fittings. The propane supply hose and the at least one propane distribution hose are fixed to the distribution manifold block using connectors without helical threads.

According to yet another aspect of the present invention, a method of forming a propane supply system is provided. The method of forming a propane supply system comprises providing a distribution manifold block having a plurality of barbed fittings, providing a propane supply tank having a propane supply hose, providing at least one appliance or system for using propane supplied from the propane supply tank, with each at least one appliance or system having a propane distribution hose, providing a plurality of tubes, positioning each of the tubes over the propane supply hose and each propane distribution hose to form tube covered hose ends, positioning each of the tube covered hose ends over one of the barbed fittings, and crimping each of the tubes to fixedly connect the propane supply hose and each propane distribution hose to the distribution manifold block. The propane supply hose and each propane distribution hose are fixed to the distribution manifold block without helical threads.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a top schematic view of a prior art propane supply system.

FIG. 2 is a top schematic view of a propane supply system of the present invention.

FIG. 3 is a perspective view of a partially completed “L” shaped distribution manifold block of the present invention in a partially completed configuration.

FIG. 4 is a cross-sectional view of the partially completed “L” shaped distribution manifold block of the present invention in the partially completed configuration.

FIG. 5 is a perspective view of an “L” shaped distribution manifold block of the present invention.

FIG. 6 is a top view of the “L” shaped distribution manifold block of the present invention.

FIG. 7 is a cross-sectional view of the “L” shaped distribution manifold block of the present invention.

FIG. 8 is a perspective view of a first embodiment of a “T” shaped distribution manifold block of the present invention.

FIG. 9 is a top view of the first embodiment of the “T” shaped distribution manifold block of the present invention.

FIG. 10 is a cross-sectional view of the first embodiment of the “T” shaped distribution manifold block of the present invention.

FIG. 11 is a perspective view of a second embodiment of a “T” shaped distribution manifold block of the present invention.

FIG. 12 is a top view of the second embodiment of the “T” shaped distribution manifold block of the present invention.

FIG. 13 is a cross-sectional view of the second embodiment of the “T” shaped distribution manifold block of the present invention.

FIG. 14 is a perspective view of a third embodiment of a “T” shaped distribution manifold block of the present invention.

FIG. 15 is a top view of the third embodiment of the “T” shaped distribution manifold block of the present invention.

FIG. 16 is a cross-sectional view of the third embodiment of the “T” shaped distribution manifold block of the present invention.

FIG. 17 is a perspective view of a fourth embodiment of a “T” shaped distribution manifold block of the present invention.

FIG. 18 is a top view of the fourth embodiment of the “T” shaped distribution manifold block of the present invention.

FIG. 19 is a cross-sectional view of the fourth embodiment of the “T” shaped distribution manifold block of the present invention.

FIG. 20 is a perspective view of a fifth embodiment of a “T” shaped distribution manifold block of the present invention.

FIG. 21 is a top view of the fifth embodiment of the “T” shaped distribution manifold block of the present invention.

FIG. 22 is a cross-sectional view of the fifth embodiment of the “T” shaped distribution manifold block of the present invention.

FIG. 23 is a perspective view of a first embodiment of an “X” shaped distribution manifold block of the present invention.

FIG. 24 is a top view of the first embodiment of the “X” shaped distribution manifold block of the present invention.

FIG. 25 is a cross-sectional view of the first embodiment of the “X” shaped distribution manifold block of the present invention.

FIG. 26 is a perspective view of a second embodiment of an “X” shaped distribution manifold block of the present invention.

FIG. 27 is a top view of the second embodiment of the “X” shaped distribution manifold block of the present invention.

FIG. 28 is a cross-sectional view of the second embodiment of the “X” shaped distribution manifold block of the present invention.

FIG. 29 is a perspective view of a third embodiment of an “X” shaped distribution manifold block of the present invention.

FIG. 30 is a top view of the third embodiment of the “X” shaped distribution manifold block of the present invention.

FIG. 31 is a cross-sectional view of the third embodiment of the “X” shaped distribution manifold block of the present invention.

FIG. 32 is a side view of the second embodiment of the “T” shaped distribution manifold block of the present invention in a final milled configuration.

FIG. 33 is a side view of the fifth embodiment of the “T” shaped distribution manifold block of the present invention in a final milled configuration.

FIG. 34 is a side view of the third embodiment of the “T” shaped distribution manifold block of the present invention in a final milled configuration.

FIG. 35 is a side view of the first embodiment of the “X” shaped distribution manifold block of the present invention in a final milled configuration.

FIG. 36 is a side view of the third embodiment of the “X” shaped distribution manifold block of the present invention in a final milled configuration.

FIG. 37 is a side view of the second embodiment of the “X” shaped distribution manifold block of the present invention in a final milled configuration.

FIG. 38 is a perspective view of an “I” shaped distribution manifold block of the present invention.

FIG. 39 is a top view of the “I” shaped distribution manifold block of the present invention.

FIG. 40 is a cross-sectional view of the “I” shaped distribution manifold block of the present invention.

FIG. 41 is a perspective view of a first embodiment of an “F” shaped distribution manifold block of the present invention.

FIG. 42 is a top view of the first embodiment of the “F” shaped distribution manifold block of the present invention.

FIG. 43 is a cross-sectional view of the first embodiment of the “F” shaped distribution manifold block of the present invention.

FIG. 44 is a perspective view of a second embodiment of an “F” shaped distribution manifold block of the present invention.

FIG. 45 is a top view of the second embodiment of the “F” shaped distribution manifold block of the present invention.

FIG. 46 is a cross-sectional view of the second embodiment of the “F” shaped distribution manifold block of the present invention.

FIG. 47 is a perspective view of a first embodiment of an “H” shaped distribution manifold block of the present invention.

FIG. 48 is a cross-sectional view of the first embodiment of the “H” shaped distribution manifold block of the present invention.

FIG. 49 is a perspective view of a second embodiment of an “H” shaped distribution manifold block of the present invention.

FIG. 50 is a cross-sectional view of the second embodiment of the “H” shaped distribution manifold block of the present invention.

FIG. 51 is a perspective view of a third embodiment of an “H” shaped distribution manifold block of the present invention.

FIG. 52 is a cross-sectional view of the third embodiment of the “H” shaped distribution manifold block of the present invention.

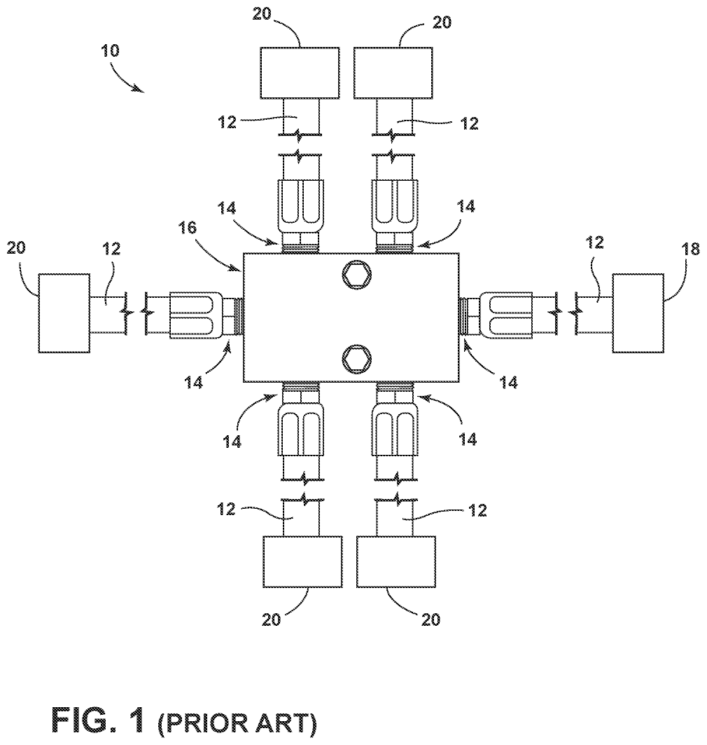

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

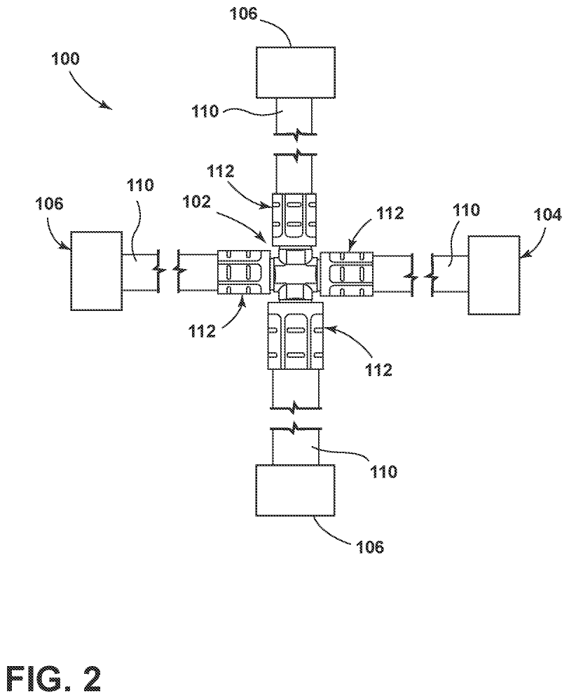

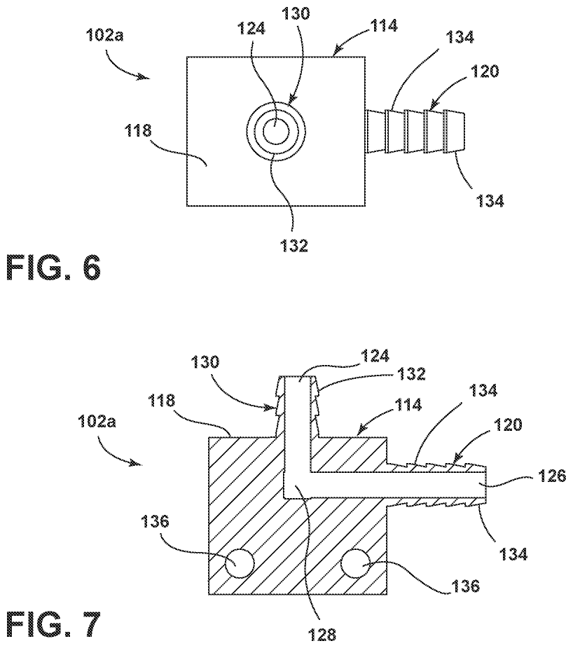

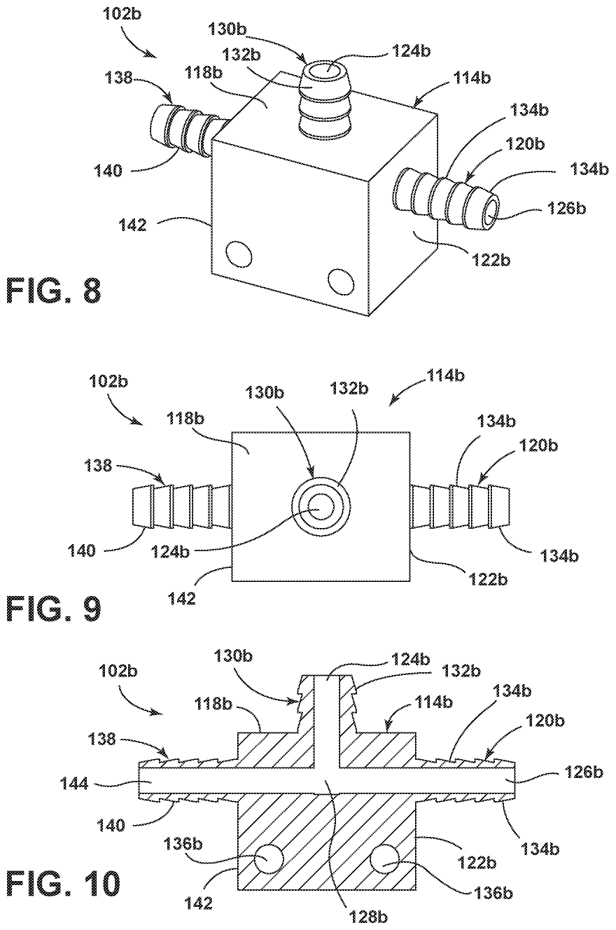

The reference number 100 (FIG. 2) generally designates a propane supply system of the present invention. The propane supply system 100 includes a distribution manifold block 102 (e.g., made of brass or aluminum) for distributing propane gas from a propane supply tank 104 (shown schematically in FIG. 2) to several appliances or systems 106 (shown schematically in FIG. 2) using the propane. The propane supply system 100 includes flexible hoses 110 (e.g., made of a mix of elastomeric rubbers and/or polyvinyl chloride (PVC)) connected to the distribution manifold block 102 by crimped tubes 112 (e.g., rings and/or ferrules made of brass or aluminum). As outlined below, the connections between the flexible hoses 110 and the distribution manifold block 102 do not include any helically threaded connections. The distribution manifold block 102 can form an “L” connection (or elbow joint) (e.g., FIGS. 5-7), a “T” connection (e.g., FIGS. 8-22 and 32-34), or an “X” connection (e.g., FIGS. 22-31 and 35-37).

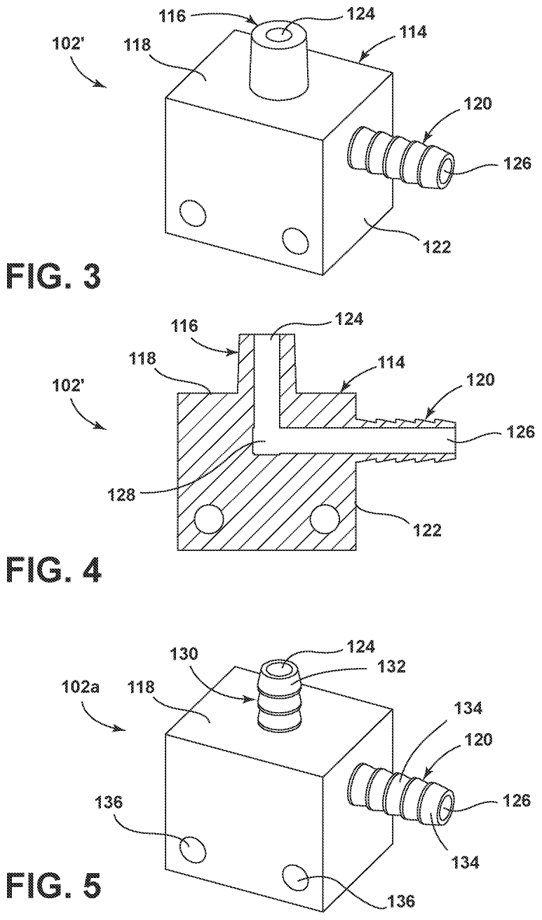

FIGS. 3 and 4 illustrate a partially completed “L” shaped distribution manifold block 102′ in a partially completed configuration. As shown in FIGS. 3-4, the partially completed “L” shaped distribution manifold block 102′ comprises a central block section 114, an unfinished frusto-conical projection 116 extending from a first side 118 of the central block section 114 and a first barbed fitting 120 extending from a second side 122 of the central block section 114. The first side 118 and the second side 122 are adjacent and perpendicular surfaces. As shown in FIG. 4, a first channel 124 extends through the unfinished frusto-conical projection 116 and into the central block section 114. A second channel 126 extends through the first barbed fitting 120 and into the central block section 114. The first channel 124 and the second channel 126 intersect as shown in FIG. 4 at an intersection point 128.

FIGS. 5-7 illustrate an “L” shaped distribution manifold block 102a. The “L” shaped distribution manifold block 102a of FIGS. 5-7 shows the “L” shaped distribution manifold block 102a in a further manufacturing step after that of the partially completed “L” shaped distribution manifold block 102′ of FIGS. 3 and 4. As illustrated in FIGS. 5-7, the unfinished frusto-conical projection 116 has been milled (or otherwise finished) to form a second barbed fitting 130 with tapered barbs 132 (e.g., National Pipe Taper (NPT) barbs). Although not shown, the first barbed fitting 120 was also formed as a frusto-conical projection before being milled (or otherwise finished) to form tapered barbs 134 on the second barbed fitting 130. Likewise, the first channel 124 and the second channel 126 can also be formed by drilling holes into the frusto-conical projections and into the central block section 114 to meet at the intersection point 128. As shown in FIGS. 5-7, the central block section 114 can have openings 136 therethrough. The openings 136 can be used to accept fasteners to fix the “L” shaped distribution manifold block 102a in position on the recreational vehicle or can be voids to assist in working the central block section 114 to have a smaller profile for use.

FIGS. 8-10 illustrate a first embodiment of a “T” shaped distribution manifold block 102b. The first embodiment of the “T” shaped distribution manifold block 102b includes a central block section 114b, a first barbed fitting 130b having tapered barbs 132b extending from a first surface 118b of the central block section 114b, a second barbed fitting 120b having tapered barbs 134b extending from a second surface 122b of the central block section 114b, and a third barbed fitting 138 having tapered barbs 140 extending from a third surface 142 of the central block section 114b.

In the illustrated embodiment, a first channel 124b extends through the first barbed fitting 130b and into the central block section 114b, a second channel 126b extends through the second barbed fitting 120b and into the central block section 114b, and a third channel 144 extends through the third barbed fitting 138 and into the central block section 114b. The first channel 124b, the second channel 126b and the third channel 144 intersect as shown in FIG. 10 at an intersection point 128b. The first channel 124b, the second channel 126b and the third channel 144 all have substantially the same diameter. The first embodiment of the “T” shaped distribution manifold block 102b is formed in the same manner as the “L” shaped distribution manifold block 102a as outlined above by milling the tapered barbs into frusto-conical projections and drilling channels therein. Moreover, the central block section 114b has openings 136b for accepting fasteners or can be voids to assist in working the central block section 114b to have a smaller profile for use.

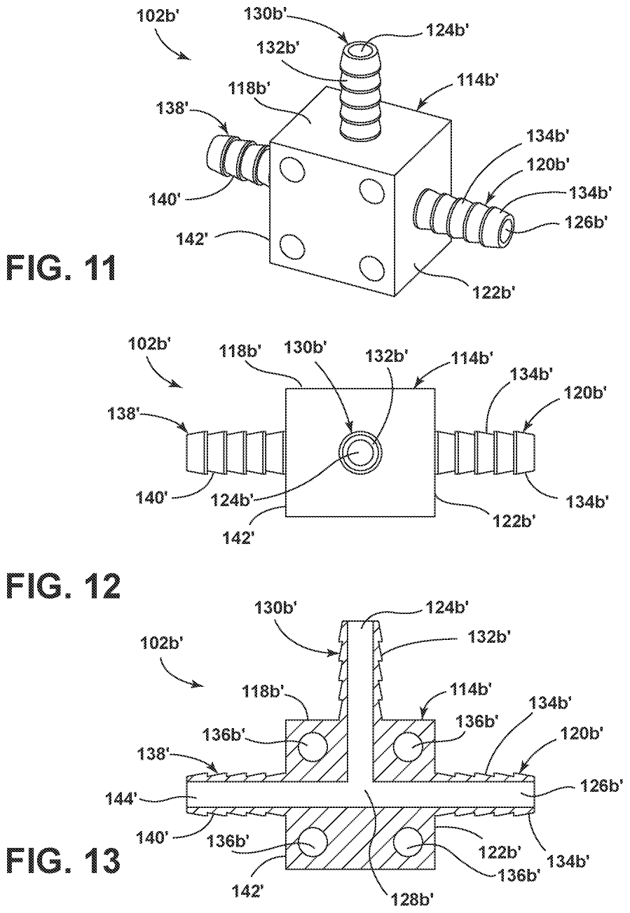

FIGS. 11-13 illustrate a second embodiment of a “T” shaped distribution manifold block 102b′. The second embodiment of the “T” shaped distribution manifold block 102b′ includes a central block section 114b′, a first barbed fitting 130b′ having tapered barbs 132b′ extending from a first surface 118b′ of the central block section 114b′, a second barbed fitting 120b′ having tapered barbs 134b′ extending from a second surface 122b′ of the central block section 114b′, and a third barbed fitting 138′ having tapered barbs 140′ extending from a third surface 142′ of the central block section 114b′.

In the illustrated embodiment, a first channel 124b′ extends through the first barbed fitting 130b′ and into the central block section 114b′, a second channel 126b′ extends through the second barbed fitting 120b′ and into the central block section 114b′, and a third channel 144′ extends through the third barbed fitting 138′ and into the central block section 114b′. The first channel 124b′, the second channel 126b′ and the third channel 144′ intersect as shown in FIG. 13 at an intersection point 128b′. The first channel 124b′, the second channel 126b′ and the third channel 144′ all have substantially the same diameter.

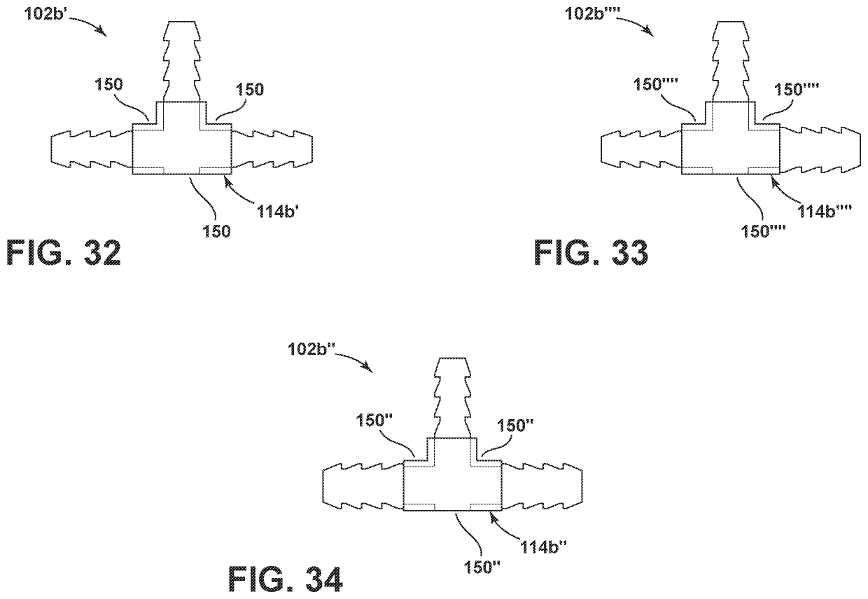

The illustrated second embodiment of the “T” shaped distribution manifold block 102b′ is formed in the same manner as the “L” shaped distribution manifold block 102a as outlined above by milling the tapered barbs into frusto-conical projections and drilling channels therein. The second embodiment of the “T” shaped distribution manifold block 102b′ is substantially identical to the first embodiment of the “T” shaped distribution manifold block 102b, except that the central block section 114b′ of the second embodiment of the “T” shaped distribution manifold block 102b′ has four openings 136b′ for accepting fasteners or can be voids to assist in working the central block section 114b′ to have a smaller profile for use. FIG. 32 illustrates the second embodiment of the “T” shaped distribution manifold block 102b′ wherein the portions of the central block section 114b′ with the four openings 136b′ have been worked to remove such sections to form open areas 150.

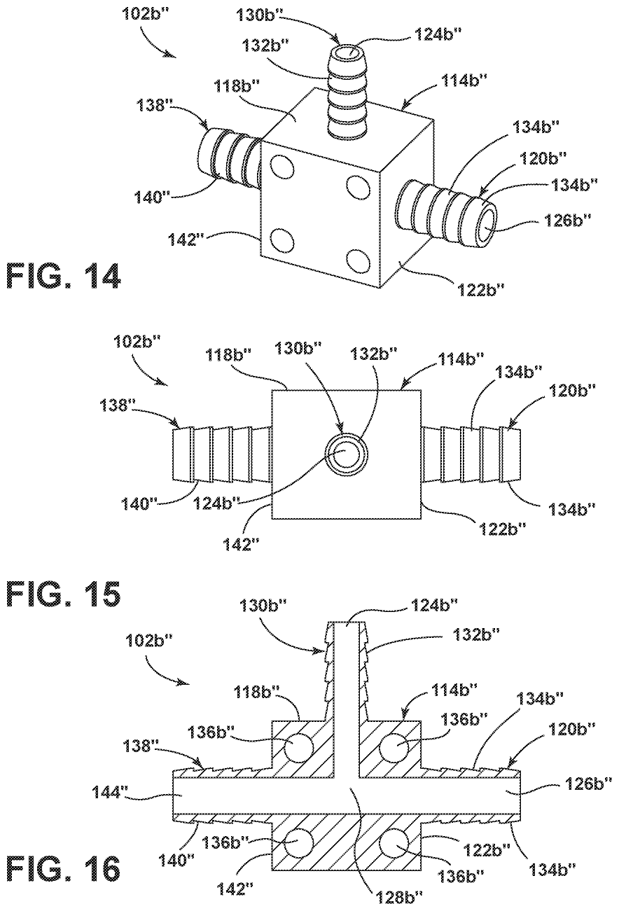

FIGS. 14-16 illustrate a third embodiment of a “T” shaped distribution manifold block 102b″. The third embodiment of the “T” shaped distribution manifold block 102b″ includes a central block section 114b″, a first barbed fitting 130b″ having tapered barbs 132b″ extending from a first surface 118b″ of the central block section 114b″, a second barbed fitting 120b″ having tapered barbs 134b″ extending from a second surface 122b″ of the central block section 114b″, and a third barbed fitting 138″ having tapered barbs 140″ extending from a third surface 142″ of the central block section 114b″.

In the illustrated embodiment, a first channel 124b″ extends through the first barbed fitting 130b″ and into the central block section 114b″, a second channel 126b″ extends through the second barbed fitting 120b″ and into the central block section 114b″, and a third channel 144″ extends through the third barbed fitting 138″ and into the central block section 114b″. The first channel 124b″, the second channel 126b″ and the third channel 144″ intersect as shown in FIG. 16 at an intersection point 128b″. The second channel 126b″ and the third channel 144″ have substantially the same diameter, but the diameter of the first channel 124b″ is smaller than the diameter of the second channel 126b″ and the third channel 144″. The second channel 126b″ and the third channel 144″ can therefore have a larger volume of propane gas pass therethrough.

The illustrated third embodiment of the “T” shaped distribution manifold block 102b″ is formed in the same manner as the “L” shaped distribution manifold block 102a as outlined above by milling the tapered barbs into frusto-conical projections and drilling channels therein. The third embodiment of the “T” shaped distribution manifold block 102b″ is substantially identical to the second embodiment of the “T” shaped distribution manifold block 102b′, except for the size of the channels as outlined above. FIG. 34 illustrates the third embodiment of the “T” shaped distribution manifold block 102b″ wherein the portions of the central block section 114b″ with the four openings 136b″ have been worked to remove such sections to form open areas 150″.

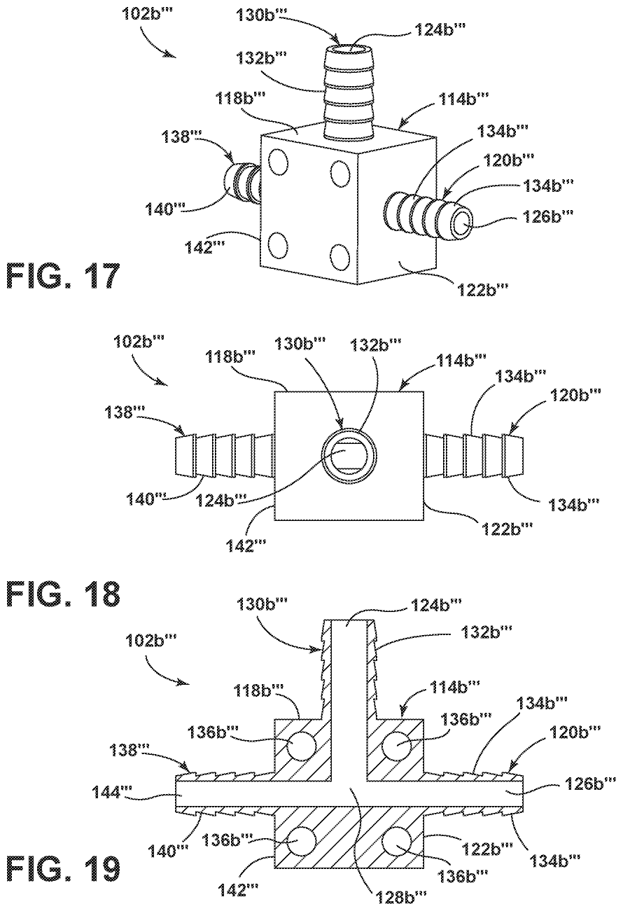

FIGS. 17-19 illustrate a fourth embodiment of a “T” shaped distribution manifold block 102b′″. The fourth embodiment of the “T” shaped distribution manifold block 102b′″ includes a central block section 114b′″, a first barbed fitting 130b′″ having tapered barbs 132b′″ extending from a first surface 118b′″ of the central block section 114b′″, a second barbed fitting 120b′″ having tapered barbs 134b′″ extending from a second surface 122b′″ of the central block section 114b′″, and a third barbed fitting 138′″ having tapered barbs 140′″ extending from a third surface 142′″ of the central block section 114b′″.

In the illustrated embodiment, a first channel 124b′″ extends through the second barbed fitting 130b′″ and into the central block section 114b′″, a second channel 126b′″ extends through the first barbed fitting 120b′″ and into the central block section 114b′″, and a third channel 144′″ extends through the third barbed fitting 138′″ and into the central block section 114b′″. The first channel 124b′″, the second channel 126b′″ and the third channel 144′″ intersect as shown in FIG. 19 at an intersection point 128b′″. The second channel 126b′″ and the third channel 144′″ have substantially the same diameter, but the diameter of the first channel 124b′″ is larger than the diameter of the second channel 126b′″ and the third channel 144′″. The first channel 124b′″ can therefore have a larger volume of propane gas pass therethrough (e.g., from the propane supply tank 104).

The illustrated fourth embodiment of the “T” shaped distribution manifold block 102b′″ is formed in the same manner as the “L” shaped distribution manifold block 102a as outlined above by milling the tapered barbs into frusto-conical projections and drilling channels therein. The fourth embodiment of the “T” shaped distribution manifold block 102b′″ is substantially identical to the second embodiment of the “T” shaped distribution manifold block 102b′, except for the size of the channels as outlined above.

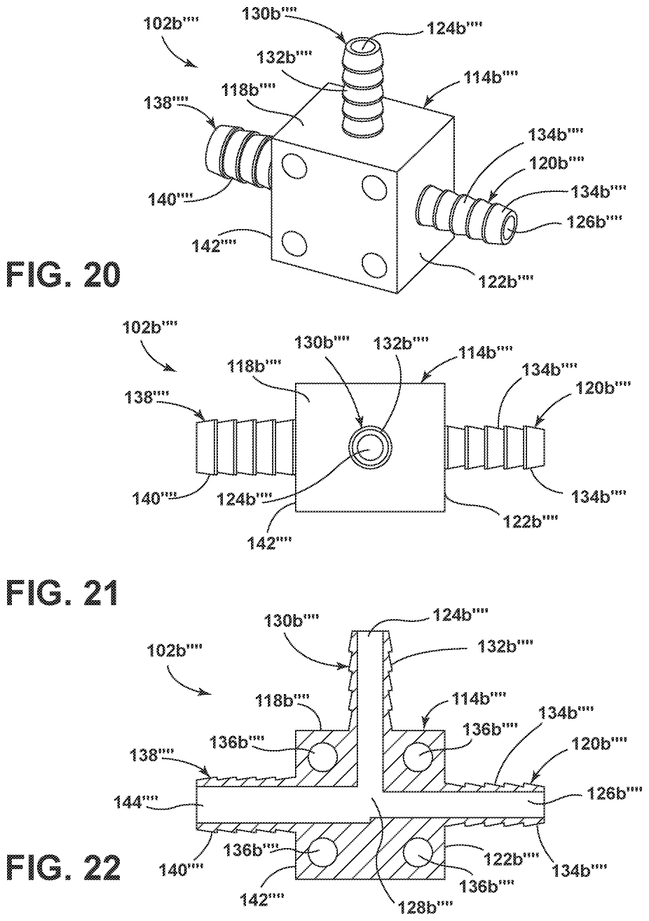

FIGS. 20-22 illustrate a fifth embodiment of a “T” shaped distribution manifold block 102b″″. The fifth embodiment of the “T” shaped distribution manifold block 102b″″ includes a central block section 114b″″, a first barbed fitting 130b“ ” having tapered barbs 132b″″ extending from a first surface 118b″″ of the central block section 114b″″, a second barbed fitting 120b“ ” having tapered barbs 134b″″ extending from a second surface 122b″″ of the central block section 114b″″, and a third barbed fitting 138“ ” having tapered barbs 140″″ extending from a third surface 142″″ of the central block section 114b″″.

In the illustrated embodiment, a first channel 124b“ ” extends through the first barbed fitting 130b″″ and into the central block section 114b″″, a second channel 126b“ ” extends through the second barbed fitting 120b″″ and into the central block section 114b″″, and a third channel 144“ ” extends through the third barbed fitting 138″″ and into the central block section 114b″″. The first channel 124b″″, the second channel 126b“ ” and the third channel 144″″ intersect as shown in FIG. 22 at an intersection point 128b″″. The first channel 124b“ ” and the second channel 126b″″ have substantially the same diameter, but the diameter of the third channel 144″″ is larger than the diameter of the first channel 124b″″ and the second channel 126b″″. The third channel 144“ ” can therefore have a larger volume of propane gas pass therethrough (e.g., from the propane tank 18).

The illustrated fifth embodiment of the “T” shaped distribution manifold block 102b″″ is formed in the same manner as the “L” shaped distribution manifold block 102a as outlined above by milling the tapered barbs into frusto-conical projections and drilling channels therein. The fifth embodiment of the “T” shaped distribution manifold block 102b″″ is substantially identical to the second embodiment of the “T” shaped distribution manifold block 102b′, except for the size of the channels as outlined above. FIG. 33 illustrates the fifth embodiment of the “T” shaped distribution manifold block 102b″″ wherein the portions of the central block section 114b″″ with the four openings 136b″″ have been worked to remove such sections to form open areas 150″″.

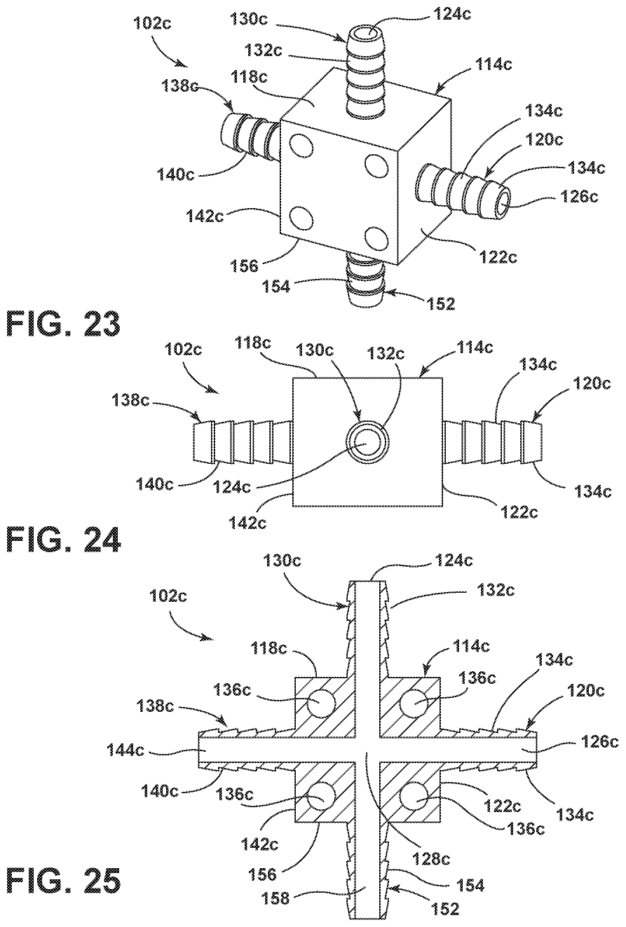

FIGS. 23-25 illustrate a first embodiment of an “X” shaped distribution manifold block 102c. The first embodiment of the “X” shaped distribution manifold block 102c includes a central block section 114c, a first barbed fitting 130c having tapered barbs 132c extending from a first surface 118c of the central block section 114c, a second barbed fitting 120c having tapered barbs 134c extending from a second surface 122c of the central block section 114c, a third barbed fitting 138c having tapered barbs 140c extending from a third surface 142c of the central block section 114c, and a fourth barbed fitting 152 having tapered barbs 154 extending from a fourth surface 156 of the central block section 114c.

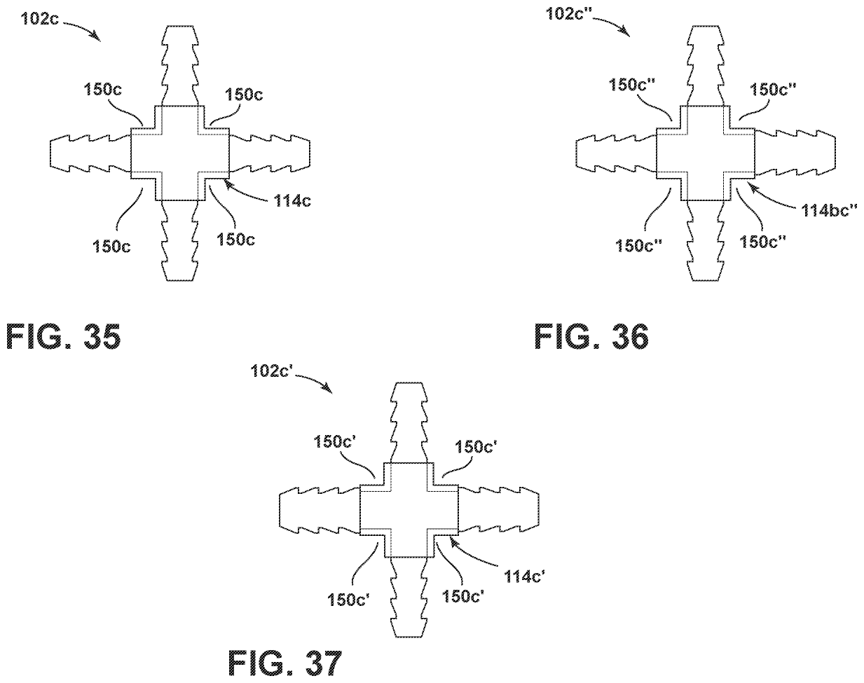

In the illustrated embodiment, a first channel 124c extends through the first barbed fitting 130c and into the central block section 114c, a second channel 126c extends through the second barbed fitting 120c and into the central block section 114c, a third channel 144c extends through the third barbed fitting 138c and into the central block section 114c, and a fourth channel 158 extends through the fourth barbed fitting 152 and into the central block section 114c. The first channel 124c, the second channel 126c, the third channel 144c and the fourth channel 158 intersect as shown in FIG. 25 at an intersection point 128c. The first channel 124c, the second channel 126c, the third channel 144c and the fourth channel 158 all have substantially the same diameter. The first embodiment of the “X” shaped distribution manifold block 102c is formed in the same manner as the “L” shaped distribution manifold block 102a as outlined above by milling the tapered barbs into frusto-conical projections and drilling channels therein. Moreover, the central block section 114c has openings 136c for accepting fasteners or can be voids to assist in working the central block section 114c to have a smaller profile for use. FIG. 35 illustrates the first embodiment of the “X” shaped distribution manifold block 102c wherein the portions of the central block section 114c with the four openings 136c have been worked to remove such sections to form open areas 150c.

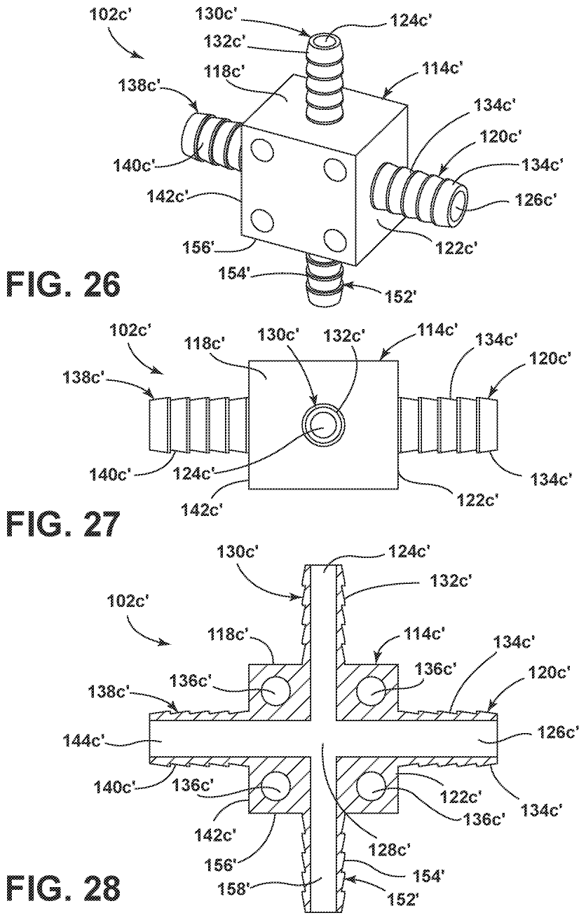

FIGS. 26-28 illustrate a second embodiment of an “X” shaped distribution manifold block 102c′. The second embodiment of the “X” shaped distribution manifold block 102c′ includes a central block section 114c′, a first barbed fitting 130c′ having tapered barbs 132c′ extending from a first surface 118c′ of the central block section 114c′, a second barbed fitting 120c′ having tapered barbs 134c′ extending from a second surface 122c′ of the central block section 114c′, a third barbed fitting 138c′ having tapered barbs 140c′ extending from a third surface 142c′ of the central block section 114c′, and a fourth barbed fitting 152′ having tapered barbs 154′ extending from a fourth surface 156′ of the central block section 114c′.

In the illustrated embodiment, a first channel 124c′ extends through the first barbed fitting 130c′ and into the central block section 114c′, a second channel 126c′ extends through the second barbed fitting 120c′ and into the central block section 114c′, a third channel 144c′ extends through the third barbed fitting 138c′ and into the central block section 114c′, and a fourth channel 158′ extends through the fourth barbed fitting 152′ and into the central block section 114c′. The first channel 124c′, the second channel 126c′, the third channel 144c′ and the fourth channel 158′ intersect as shown in FIG. 28 at an intersection point 128c′. The first channel 124c′ and the fourth channel 158′ both have substantially the same diameter. Likewise, the second channel 126c′ and the third channel 144c′ both have substantially the same diameter.

The illustrated second embodiment of the “X” shaped distribution manifold block 102c′ is formed in the same manner as the “L” shaped distribution manifold block 102a as outlined above by milling the tapered barbs into frusto-conical projections and drilling channels therein. The second embodiment of the “X” shaped distribution manifold block 102c′ is substantially identical to the first embodiment of the “X” shaped distribution manifold block 102c, except for the size of the channels as outlined above. FIG. 37 illustrates the second embodiment of the “X” shaped distribution manifold block 102c′ wherein the portions of the central block section 114c′ with the four openings 136c′ have been worked to remove such sections to form open areas 150c′.

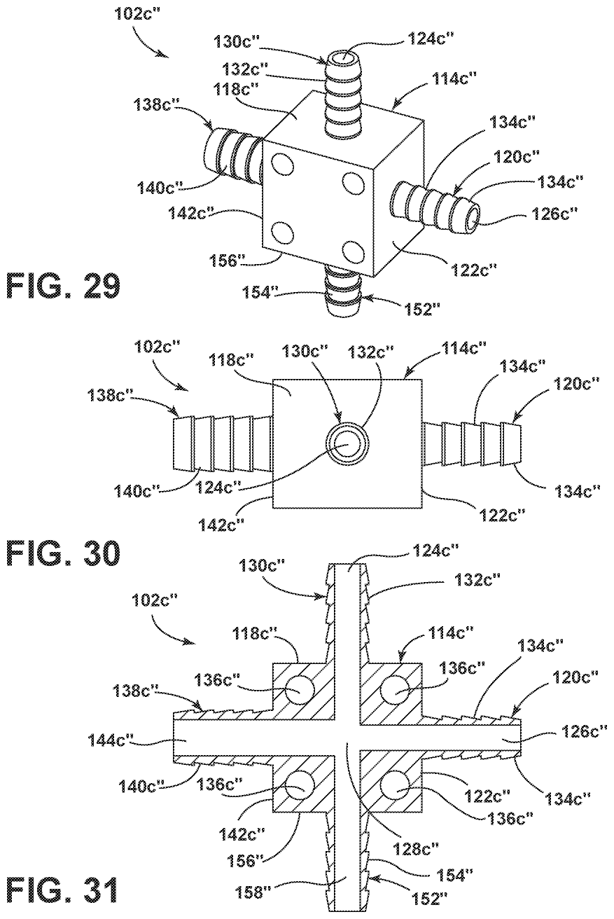

FIGS. 29-31 illustrate a third embodiment of an “X” shaped distribution manifold block 102c″. The third embodiment of the “X” shaped distribution manifold block 102c″ includes a central block section 114c″, a first barbed fitting 130c″ having tapered barbs 132c″ extending from a first surface 118c″ of the central block section 114c″, a second barbed fitting 120c″ having tapered barbs 134c″ extending from a second surface 122c″ of the central block section 114c″, a third barbed fitting 138c″ having tapered barbs 140c″ extending from a third surface 142c″ of the central block section 114c″, and a fourth barbed fitting 152″ having tapered barbs 154″ extending from a fourth surface 156″ of the central block section 114c″.

In the illustrated embodiment, a first channel 124c″ extends through the first barbed fitting 130c″ and into the central block section 114c″, a second channel 126c″ extends through the second barbed fitting 120c″ and into the central block section 114c″, a third channel 144c″ extends through the third barbed fitting 138c″ and into the central block section 114c″, and a fourth channel 158″ extends through the fourth barbed fitting 152″ and into the central block section 114c″. The first channel 124c″, the second channel 126c″, the third channel 144c″ and the fourth channel 158″ intersect as shown in FIG. 31 at an intersection point 128c″. The first channel 124c″, the second channel 126c″ and the fourth channel 158″ all have substantially the same diameter. The third channel 144c has a diameter larger than the first channel 124c″, the second channel 126c″ and the fourth channel 158″.

The illustrated third embodiment of the “X” shaped distribution manifold block 102c″ is formed in the same manner as the “L” shaped distribution manifold block 102a as outlined above by milling the tapered barbs into frusto-conical projections and drilling channels therein. The third embodiment of the “X” shaped distribution manifold block 102c″ is substantially identical to the first embodiment of the “X” shaped distribution manifold block 102c, except for the size of the channels as outlined above. FIG. 36 illustrates the third embodiment of the “X” shaped distribution manifold block 102c″ wherein the portions of the central block section 114c″ with the four openings 136c″ have been worked to remove such sections to form open areas 150c″.

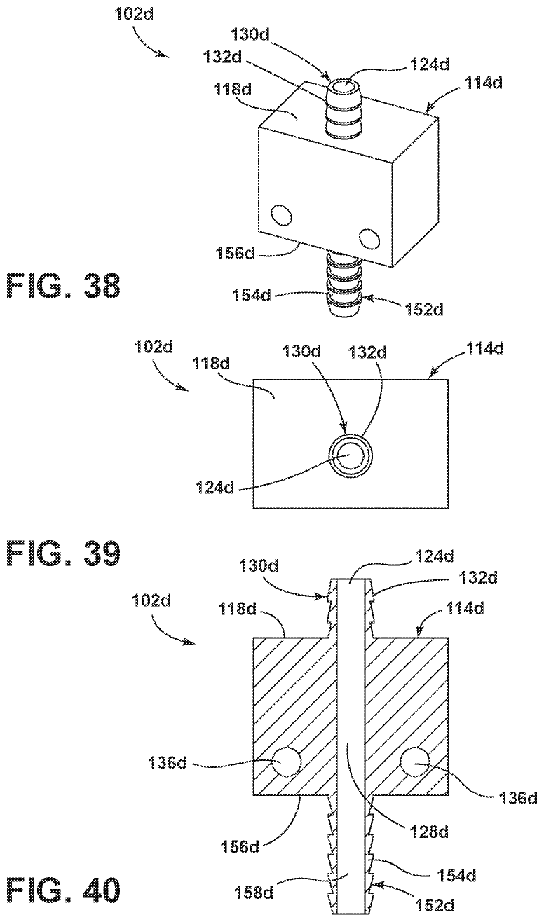

FIGS. 38-40 illustrate an embodiment of an “I” shaped distribution manifold block 102d. The “I” shaped distribution manifold block 102d includes a central block section 114d, a first barbed fitting 130d having tapered barbs 132d extending from a first surface 118d of the central block section 114d and a second barbed fitting 152d having tapered barbs 154d extending from a fourth surface 156d of the central block section 114d.

In the illustrated embodiment, a first channel 124d extends through the first barbed fitting 130d and into the central block section 114d and a second channel 158d extends through the second barbed fitting 152d and into the central block section 114d. The first channel 124d and the second channel 158d intersect as shown in FIG. 40 at an intersection point 128d. The first channel 124d and the second channel 158d both have substantially the same diameter and are colinear. The illustrated “I” shaped distribution manifold block 102d is formed in the same manner as the “L” shaped distribution manifold block 102a as outlined above by milling the tapered barbs into frusto-conical projections and drilling channels therein. The “I” shaped distribution manifold block 102d has two openings 136d for accepting fasteners or can be voids to assist in working the central block section 114d to have a smaller profile for use.

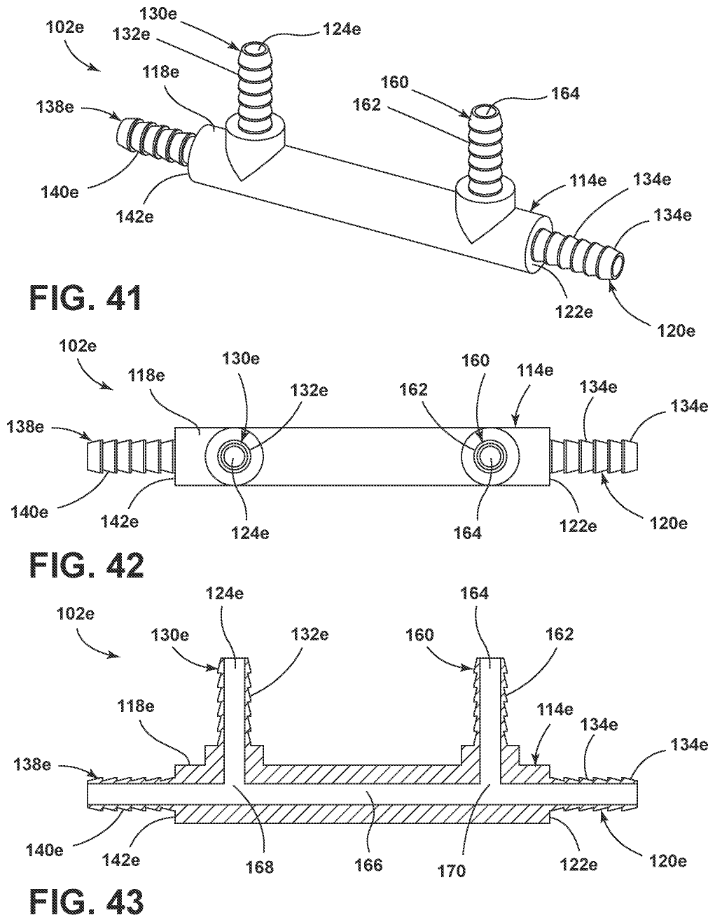

FIGS. 41-43 illustrate a first embodiment of an “F” shaped distribution manifold block 102e. The first embodiment of the “F” shaped distribution manifold block 102e includes a central block section 114e, a first upper side barbed fitting 130e having tapered barbs 132e extending from a first side 118e of the central block section 114e, a second upper side barbed fitting 160 having tapered barbs 162 extending from the first side 118e of the central block section 114e and parallel with the first upper side barbed fitting 130e, a second barbed fitting 120e having tapered barbs 134e extending from a second surface 122e of the central block section 114e, and a third barbed fitting 138e having tapered barbs 140e extending from a third surface 142e of the central block section 114e.

In the illustrated embodiment, a first channel 124e extends through the first upper side barbed fitting 130e and into the central block section 114e, a second channel 164 extends through the second upper side barbed fitting 160 and into the central block section 114e, and a third channel 166 extends through both the second barbed fitting 120e and the third barbed fitting 138e and through the central block section 114e. The first channel 124e intersects the third channel 166 as shown in FIG. 42 at a first intersection point 168. The second channel 164 intersects the third channel 166 as shown in FIG. 42 at a second intersection point 170. The first channel 124e, the second channel 164 and the third channel 166 all have substantially the same diameter. The illustrated first embodiment of the “F” shaped distribution manifold block 102e can be formed in the same manner as the “L” shaped distribution manifold block 102a as outlined above by milling the tapered barbs into frusto-conical projections and drilling channels therein.

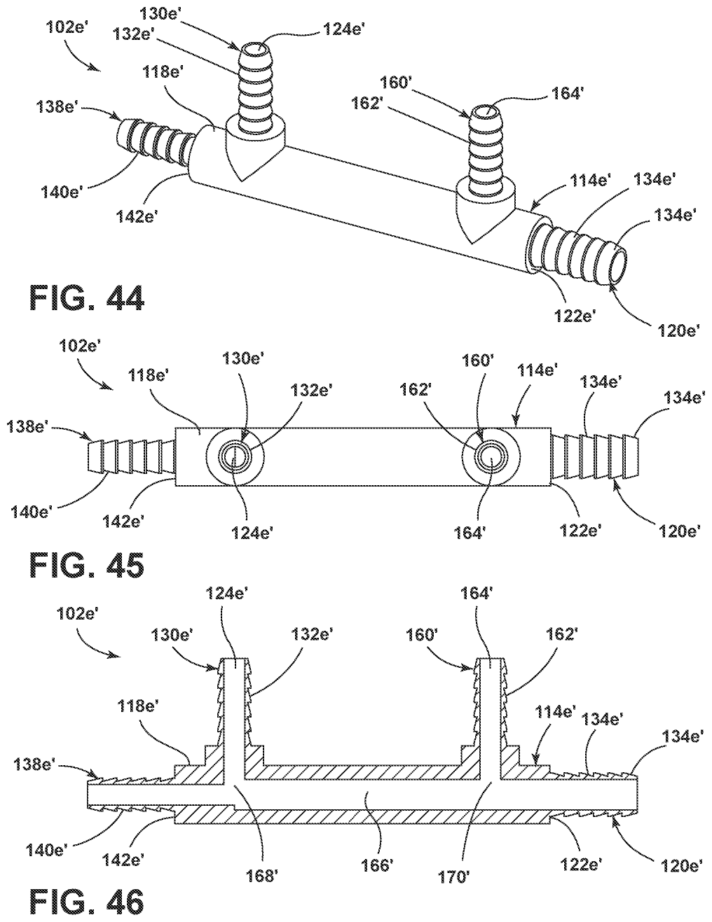

FIGS. 44-46 illustrate a second embodiment of an “F” shaped distribution manifold block 102e′. The second embodiment of the “F” shaped distribution manifold block 102e′ includes a central block section 114e′, a first upper side barbed fitting 130e′ having tapered barbs 132e′ extending from a first side 118e′ of the central block section 114e′, a second upper side barbed fitting 160′ having tapered barbs 162′ extending from the first side 118e′ of the central block section 114e′ and parallel with the first upper side barbed fitting 130e′, a second barbed fitting 120e′ having tapered barbs 134e′ extending from a second surface 122e′ of the central block section 114e′, and a third barbed fitting 138e′ having tapered barbs 140e′ extending from a third surface 142e′ of the central block section 114e′.

In the illustrated embodiment, a first channel 124e′ extends through the first upper side barbed fitting 130e′ and into the central block section 114e′, a second channel 164′ extends through the second upper side barbed fitting 160′ and into the central block section 114e′, and a third channel 166′ extends through both the second barbed fitting 120e′ and the third barbed fitting 138e′ and through the central block section 114e′. The first channel 124e′ intersects the third channel 166′ as shown in FIG. 46 at a first intersection point 168′. The second channel 164′ intersects the third channel 166′ as shown in FIG. 46 at a second intersection point 170′. The first channel 124e′ and the second channel 164′ have substantially the same diameter. The third channel 166′ in the third barbed fitting 138′ has substantially the same diameter as the first channel 124e′ and the second channel 164′ up to the first intersection point 168′. The rest of the third channel 166′ has a larger diameter than the first channel 124e′ and the second channel 164′. The illustrated second embodiment of the “F” shaped distribution manifold block 102e′ can be formed in the same manner as the “L” shaped distribution manifold block 102a as outlined above by milling the tapered barbs into frusto-conical projections and drilling channels therein.

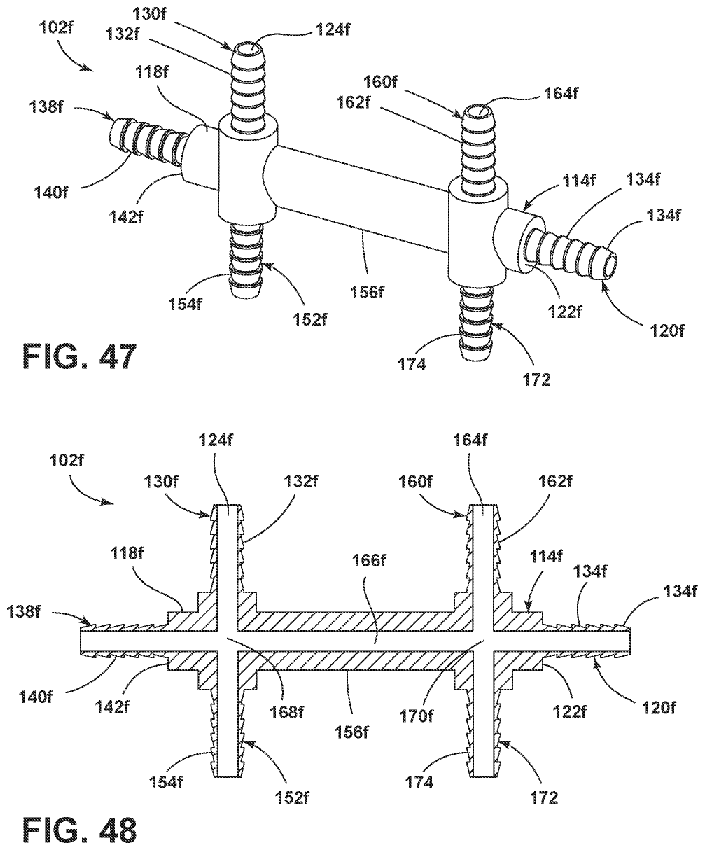

FIGS. 47-48 illustrate a first embodiment of an “H” shaped distribution manifold block 102f. The first embodiment of the “H” shaped distribution manifold block 102f includes a central block section 114f, a first upper side barbed fitting 130f having tapered barbs 132f extending from a first side 118f of the central block section 114f, a second upper side barbed fitting 160f having tapered barbs 162f extending from the first side 118f of the central block section 114f and parallel with the first upper side barbed fitting 130f, a second barbed fitting 120f having tapered barbs 134f extending from a second surface 122f of the central block section 114f, a third barbed fitting 138f having tapered barbs 140f extending from a third surface 142f of the central block section 114f′, a first lower side barbed fitting 152f having tapered barbs 154f extending from a lower side 156f of the central block section 114f, a second lower side barbed fitting 172 having tapered barbs 174 extending from the lower side 156f of the central block section 114f and parallel with the first lower side barbed fitting 152f.

In the illustrated embodiment, a first channel 124f extends through the first upper side barbed fitting 130f, into the central block section 114f, and through the first lower side barbed fitting 152f. A second channel 164f extends through the second upper side barbed fitting 160f, into the central block section 114f, and through the second lower side barbed fitting 172. A third channel 166f extends through both the second barbed fitting 120f and the third barbed fitting 138f and through the central block section 114f. The first channel 124f intersects the third channel 166f as shown in FIG. 48 at a first intersection point 168f. The second channel 164f intersects the third channel 166f as shown in FIG. 48 at a second intersection point 170f. The first channel 124f, the second channel 164f, and the third channel 166f all have substantially the same diameter. The illustrated first embodiment of the “H” shaped distribution manifold block 102f can be formed in the same manner as the “L” shaped distribution manifold block 102a as outlined above by milling the tapered barbs into frusto-conical projections and drilling channels therein.

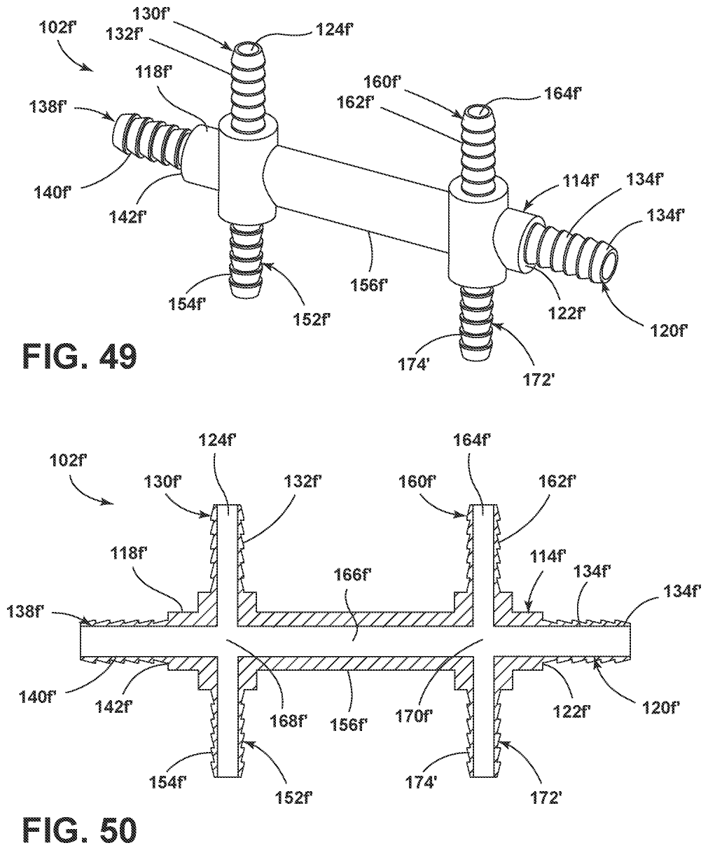

FIGS. 49-50 illustrate a second embodiment of an “H” shaped distribution manifold block 102f′. The second embodiment of the “H” shaped distribution manifold block 102f′ includes a central block section 114f′, a first upper side barbed fitting 130f′ having tapered barbs 132f′ extending from a first side 118f′ of the central block section 114f′, a second upper side barbed fitting 160f′ having tapered barbs 162f′ extending from the first side 118f′ of the central block section 114f′ and parallel with the first upper side barbed fitting 130f′, a second barbed fitting 120f′ having tapered barbs 134f′ extending from a second surface 122f′ of the central block section 114f′, a third barbed fitting 138f′ having tapered barbs 140f′ extending from a third surface 142f′ of the central block section 114f′, a first lower side barbed fitting 152f′ having tapered barbs 154f′ extending from a lower side 156f′ of the central block section 114f′, a second lower side barbed fitting 172′ having tapered barbs 174′ extending from the lower side 156f′ of the central block section 114f′ and parallel with the first lower side barbed fitting 152f′.

In the illustrated embodiment, a first channel 124f′ extends through the first upper side barbed fitting 130f′, into the central block section 114f′, and through the first lower side barbed fitting 152f′. A second channel 164f′ extends through the second upper side barbed fitting 160f′, into the central block section 114f′, and through the second lower side barbed fitting 172′. A third channel 166f′ extends through both the second barbed fitting 120f′ and the third barbed fitting 138f′ and through the central block section 114f′. The first channel 124f′ intersects the third channel 166f′ as shown in FIG. 50 at a first intersection point 168f′. The second channel 164f′ intersects the third channel 166f′ as shown in FIG. 50 at a second intersection point 170f′. The first channel 124f′ and the second channel 164f′ both have substantially the same diameter. The third channel 166f′ has a larger diameter than the first channel 124f′ and the second channel 164f′. The illustrated second embodiment of the “H” shaped distribution manifold block 102f′ can be formed in the same manner as the “L” shaped distribution manifold block 102a as outlined above by milling the tapered barbs into frusto-conical projections and drilling channels therein.

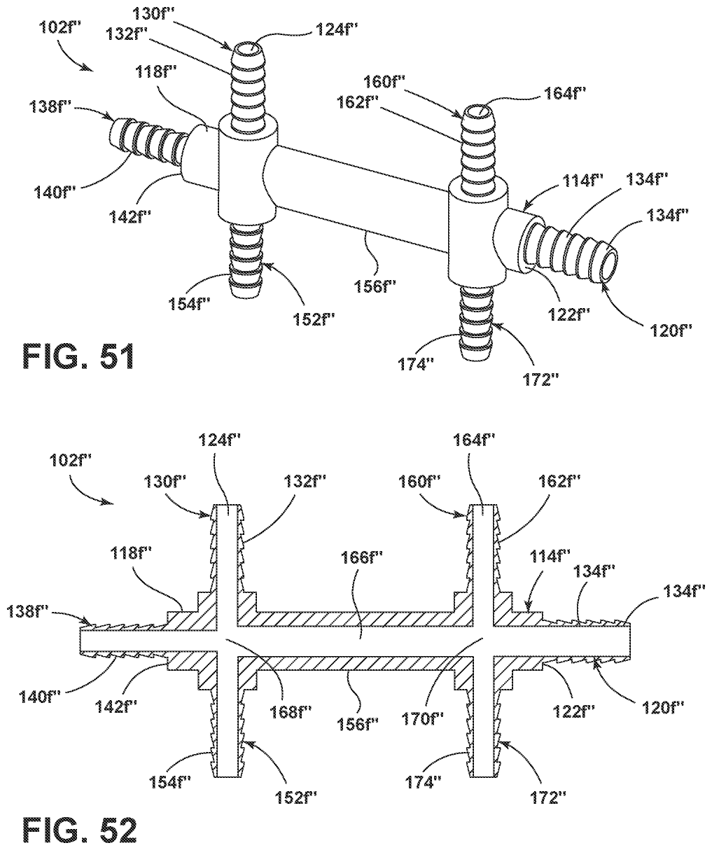

FIGS. 51-52 illustrate a third embodiment of an “H” shaped distribution manifold block 102f″. The third embodiment of the “H” shaped distribution manifold block 102f″ includes a central block section 114f″, a first upper side barbed fitting 130f″ having tapered barbs 132f″ extending from a first side 118f″ of the central block section 114f″, a second upper side barbed fitting 160f″ having tapered barbs 162f″ extending from the first side 118f″ of the central block section 114f″ and parallel with the first upper side barbed fitting 130f″, a second barbed fitting 120f″ having tapered barbs 134f″ extending from a second surface 122f″ of the central block section 114f″, a third barbed fitting 138f″ having tapered barbs 140f″ extending from a third surface 142f″ of the central block section 114f″, a first lower side barbed fitting 152f″ having tapered barbs 154f″ extending from a lower side 156f″ of the central block section 114f″, a second lower side barbed fitting 172″ having tapered barbs 174″ extending from the lower side 156f″ of the central block section 114f″ and parallel with the first lower side barbed fitting 152f″.

In the illustrated embodiment, a first channel 124f″ extends through the first upper side barbed fitting 130f″, into the central block section 114f″, and through the first lower side barbed fitting 152f″. A second channel 164f″ extends through the second upper side barbed fitting 160f″, into the central block section 114f″, and through the second lower side barbed fitting 172″. A third channel 166f″ extends through both the second barbed fitting 120f″ and the third barbed fitting 138f″ and through the central block section 114f″. The first channel 124f″ intersects the third channel 166f″ as shown in FIG. 52 at a first intersection point 168f″. The second channel 164f″ intersects the third channel 166f″ as shown in FIG. 52 at a second intersection point 170f″. The first channel 124f″ and the second channel 164f″ have substantially the same diameter. The third channel 166f″ in the third barbed fitting 138f″ has substantially the same diameter as the first channel 124f″ and the second channel 164f″ up to the first intersection point 168f″. The rest of the third channel 166f″ has a larger diameter than the first channel 124f″ and the second channel 164f″. The illustrated third embodiment of the “H” shaped distribution manifold block 102f″ can be formed in the same manner as the “L” shaped distribution manifold block 102a as outlined above by milling the tapered barbs into frusto-conical projections and drilling channels therein.

The propane supply system 100 of the present invention is formed by positioning a cylinder or tube over the ends of the flexible hoses 110 and then positioning the ends of the flexible hoses 110 over the barbed fittings 120, 130, 138, 152, 120b, 130b, etc. The cylinder is then crimped to form the crimped tubes 112. The flexible hoses 110 are then fixedly connected to the distribution manifold block 102a, 102b, 102c, 102b′, etc. Since the connections of the flexible hoses 110 to the distribution manifold block 102a, 102b, 102c, 102b′, etc. do not include any helical threaded connections, the connections are less prone to leakage. Furthermore, with the cylinders forming the crimped tubes 112 and the distribution manifold block 102a, 102b, 102c, 102b′, etc. all being formed of brass or all being formed of aluminum, the propane supply system 100 of the present invention is less susceptible to leaks, rusting and corrosion.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A propane supply system comprising:
a distribution manifold block;
a propane supply tank;
at least one appliance or system for using propane supplied from the propane supply tank;
a propane supply hose connecting the propane supply tank to the distribution manifold block; and
at least one propane distribution hose, each at least one propane distribution hose connecting the distribution manifold block to one of the at least one appliance or system for using propane;
wherein the propane supply hose and the at least one propane distribution hose are fixed to the distribution manifold block using connectors without helical threads.

2. The propane supply system according to claim 1, wherein:
the connectors comprise barbed fittings of the distribution manifold block along with crimped tubes over each of the propane supply hose and the at least one propane distribution hose and the associated barbed fittings.

3. The propane supply system according to claim 2, wherein:
the distribution manifold block and the crimped tubes are formed of brass.

4. The propane supply system according to claim 1, wherein:
the distribution manifold block forms an “L” connection with an L-shaped channel therethrough.

5. The propane supply system according to claim 1, wherein:
the at least one appliance or system comprises a pair of appliances or systems for using propane;
the at least one propane distribution hose comprises a pair of propane distribution hoses; and
the distribution manifold block forms a “T” connection with a T-shaped channel therethrough.

6. The propane supply system according to claim 1, wherein:
the at least one appliance or system comprises three appliances or systems for using propane;
the at least one propane distribution hose comprises three propane distribution hoses; and
the distribution manifold block forms an “X” connection with an X-shaped channel therethrough.

7. The propane supply system according to claim 1, wherein:
the at least one appliance or system comprises a pair of appliances or systems for using propane;
the at least one propane distribution hose comprises four propane distribution hoses; and
the distribution manifold block forms an “F” connection with an F-shaped channel therethrough.

8. The propane supply system according to claim 1, wherein:
the at least one appliance or system comprises a pair of appliances or systems for using propane;
the at least one propane distribution hose comprises six propane distribution hoses; and
the distribution manifold block forms an “H” connection with an H-shaped channel therethrough.

9. The propane supply system according to claim 2, wherein:
the distribution manifold block and the crimped tubes are formed of aluminum.

10. A propane supply system comprising:
a distribution manifold block having a plurality of barbed fittings;
a propane supply tank;
at least one appliance or system for using propane supplied from the propane supply tank;
a propane supply hose connecting the propane supply tank to the distribution manifold block;
at least one propane distribution hose, each at least one propane distribution hose connecting the distribution manifold block to one of the at least one appliance or system for using propane; and
a plurality of crimped tubes, with the crimped tubes being positioned over each of the propane supply hose and the at least one propane distribution hose and the associated barbed fittings;
wherein the propane supply hose and the at least one propane distribution hose are fixed to the distribution manifold block using connectors without helical threads.

11. The propane supply system according to claim 10, wherein:
the distribution manifold block forms an “L” connection with an L-shaped channel therethrough.

12. The propane supply system according to claim 10, wherein:
the at least one appliance or system comprises a pair of appliances or systems for using propane;
the at least one propane distribution hose comprises a pair of propane distribution hoses; and
the distribution manifold block forms a “T” connection with a T-shaped channel therethrough.

13. The propane supply system according to claim 10, wherein:
the at least one appliance or system comprises three appliances or systems for using propane;
the at least one propane distribution hose comprises three propane distribution hoses; and
the distribution manifold block forms an “X” connection with an X-shaped channel therethrough.

14. The propane supply system according to claim 10, wherein:
the at least one appliance or system comprises a pair of appliances or systems for using propane;
the at least one propane distribution hose comprises four propane distribution hoses; and
the distribution manifold block forms an “F” connection with an F-shaped channel therethrough.

15. The propane supply system according to claim 10, wherein:
the at least one appliance or system comprises a pair of appliances or systems for using propane;
the at least one propane distribution hose comprises six propane distribution hoses; and
the distribution manifold block forms an “H” connection with an H-shaped channel therethrough.

16. The propane supply system according to claim 10, wherein:
the distribution manifold block and the crimped tubes are formed of brass.

17. The propane supply system according to claim 10, wherein:
the distribution manifold block and the crimped tubes are formed of aluminum.

18. A method of forming a propane supply system comprising:
providing a distribution manifold block having a plurality of barbed fittings;
providing a propane supply tank having a propane supply hose;
providing at least one appliance or system for using propane supplied from the propane supply tank, each at least one appliance or system having a propane distribution hose;
providing a plurality of tubes;
positioning each of the tubes over the propane supply hose and each propane distribution hose to form tube covered hose ends;
positioning each of the tube covered hose ends over one of the barbed fittings; and
crimping each of the tubes to fixedly connect the propane supply hose and each propane distribution hose to the distribution manifold block;
wherein the propane supply hose and each propane distribution hose are fixed to the distribution manifold block without helical threads.

19. The method according to claim 18, wherein:
the distribution manifold block and the tubes are formed of brass.

20. The method according to claim 18, wherein:
the distribution manifold block and the tubes are formed of aluminum.
